(19) United States
(12) Patent Application Publication
(10) Pub. No.: US 2009/0174198 A1
(43) Pub. Date: Jul. 9, 2009

(54) Device for shielding a pressure relief valve from projecting debris

(76) Inventor: Freddie L. Parson, Georgetown, DE (US)

Correspondence Address: NW-IP-LAW, 6039 E. Grant RD., Tucson, AZ, 85712, US

(21) Appl. No.: 12/008,180

(22) Filed: Jan. 8, 2008

Related U.S. Application Data
(60) Provisional application No. 60/971,351.

(51) Int. Cl. B60R 19/16

(52) U.S. Cl. 293/112

(57) ABSTRACT

The present invention features a device for shielding a pressure relief valve from projecting debris, the device comprises a first plate and a second plate, the pressure relief valve is located on a side exterior of a vehicle and is held in a stationary position through a support member that extends outwardly from the vehicle, the first plate attaches to and extends outwardly from the second plate, the first plate is positioned between the pressure relief valve and a tire of a vehicle, the second plate is attached to the support member.

This application claims priority to the U.S. Provisional Patent Application Ser. No. 60/971,351, filed November, 2007, the disclosure of which is enclosed herein by reference.

### BACKGROUND OF THE INVENTION

Commercial vehicles such as the 800-GOT-JUNK trucks are used to transport various items (trash, junk, furniture, construction materials, and the like) from residential/commercial properties and construction sites to landfills and other locations.

Many of these commercial vehicles have a pressure relief valve (hereinafter “PRV”) being positioned on the side exterior of the trucks, and behind a wheel. When in motion, the wheel can throw debris towards the PRV. The PRV can become clogged by the debris thrown at it. As the debris cover the PRV, the PRV cannot properly ventilate. The lack of ventilation eventually causes the vehicle to lose the ability to accelerate properly. Therefore, there is a need for a device to prevent clogging of the PRV.

### BRIEF DESCRIPTION OF THE DRAWINGS

FIG. 1 shows a vehicle having an exposed pressure relief valve disposed on a support member, wherein the support member is located behind a wheel.

FIG. 2 shows a perspective view of an exemplary device comprising a first plate and a second plate.

FIGS. 3 and 4, each showing a different cross sectional view from a different cross section as indicated in FIG. 2.

FIG. 5A shows the exemplary device being mounted onto a support member. FIG. 5B shows a side view of FIG. 5A.

FIG. 6 shows a perspective view of the exemplary device with a third plate and a door member.

FIGS. 7 and 8, each showing a different cross sectional view from a different cross section as indicated in FIG. 6.

FIG. 9 shows the exemplary device being mounted onto a support member.

### DESCRIPTION OF PREFERRED EMBODIMENTS

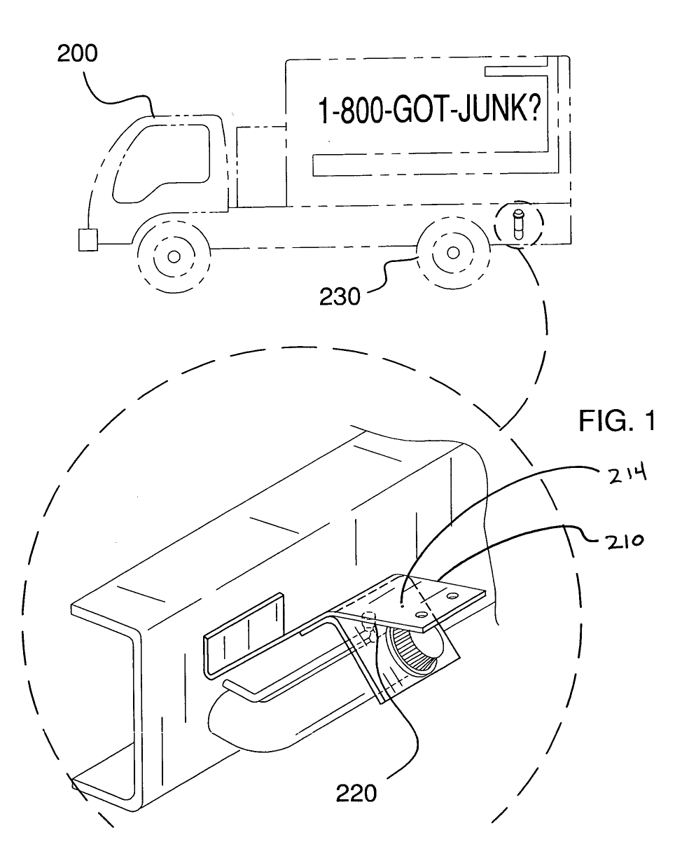

The present invention features a device 100 for shielding a pressure relief valve 220 (hereinafter “PRV”) from projecting debris. Generally, the PRV 220 is located on a side exterior of a vehicle 200 and is held in a stationary position through a support member 210 that extends outwardly from the vehicle 200 (see FIG. 1).

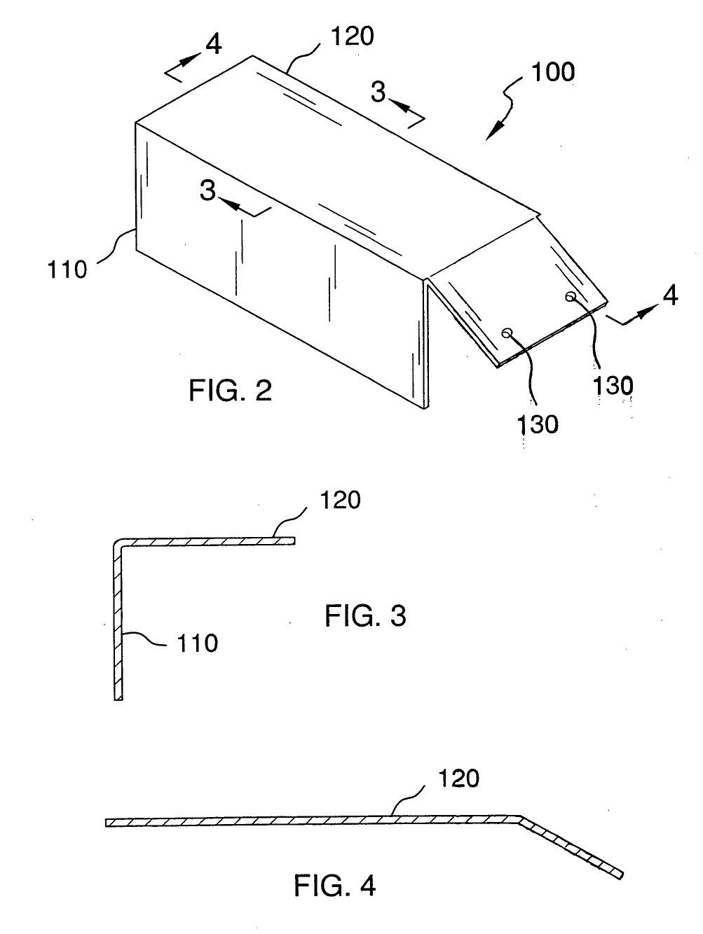

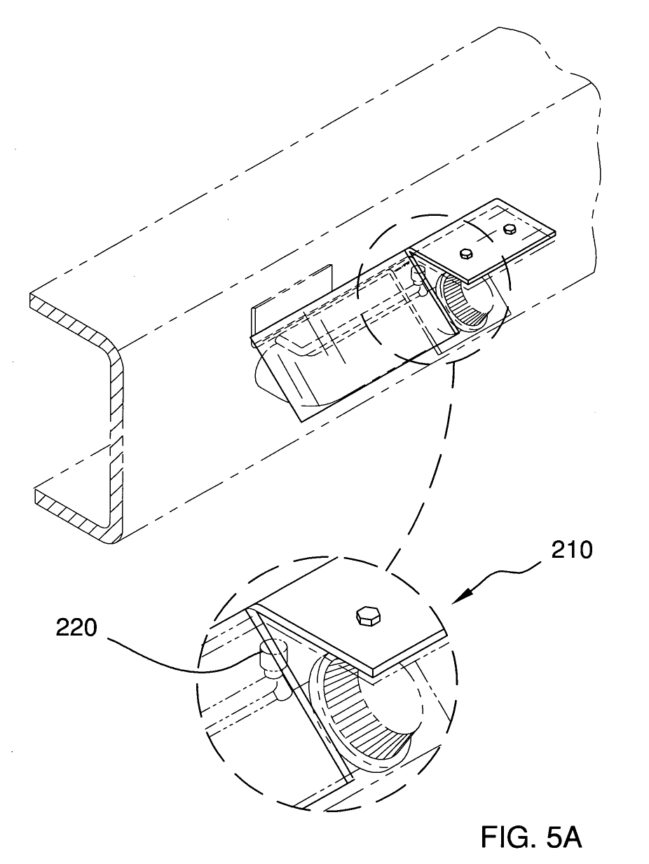

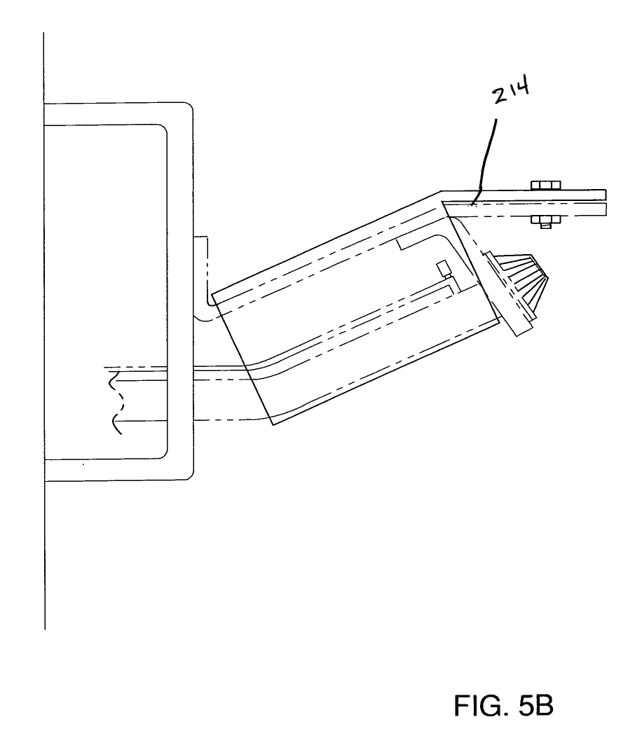

Referring to FIG. 2, FIG. 3, FIG. 4, and FIGS. 5A and 5B, the device 100 comprises a first plate 110 and a second plate 120. The first plate 110 attaches to and extends outwardly from the second plate 120. In some embodiments, the second plate is horizontal with respect to the ground and the first plate is vertical with respect to the ground. When the device 100 is installed onto a vehicle 200, the first plate 110 is positioned between the PRV 220 and a tire 230 of a vehicle 200, wherein the tire 230 can directly project or indirectly cause debris to be projected towards the direction of the PRV 220. The device 100 can be attached to the support member 210 via any means, e.g., welding, gluing, clamping, bolting. In some embodiments, the second plate 120 can be attached to the support member 210 by bolting the second plate 120 to the support member 210 (see FIGS. 5A and 5B). In some embodiments, the second plate 120 comprises at least one pre-drilled hole 130 (e.g., two pre-drilled hole) to facilitate the bolting of the second plate 120 to the support member (see FIG. 2). For example, FIG. 5A shows the second plate 120 being bolted to (e.g., on top of) the supporting member 210 through a pre-drilled hole 130.

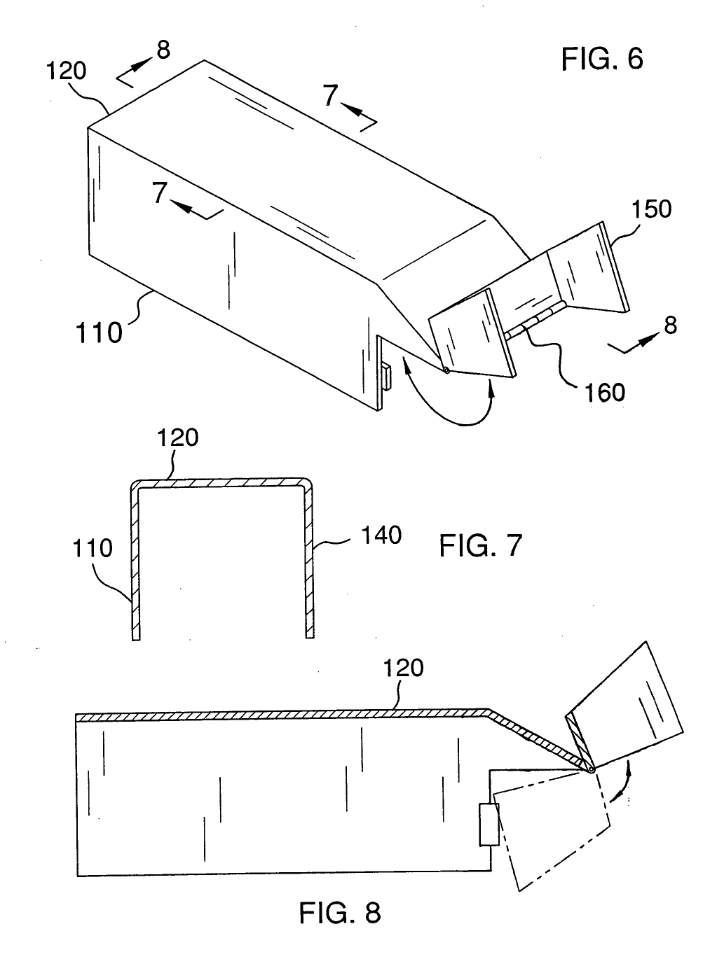

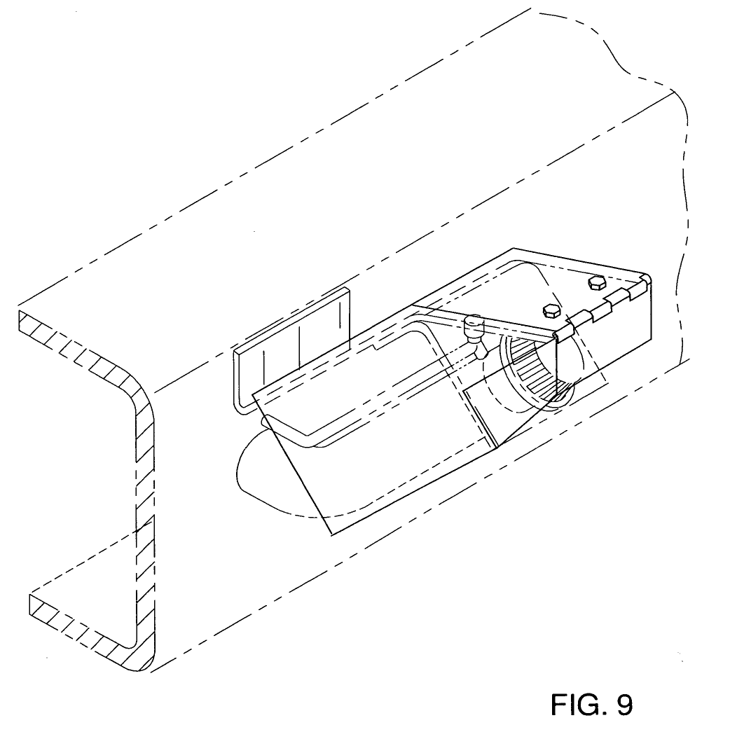

Referring to FIG. 6, FIG. 7, FIG. 8 and FIG. 9, in some embodiments, the device 100 further comprises a third plate 140 that attaches to and extends outwardly from the second plate 120, and a door member rotatably mounted (e.g., via a hinge 160) to the second plate 120, wherein the first plate 110, second plate 120, third plate 140 and door member 150 form an enclosure around the pressure relief valve.

In some embodiments, at least one component of the device 100 (e.g., first plate 110, second plate 120, third plate 140, door member 150) is constructed from a rigid material, for example, metal (e.g., iron, alloys, aluminum), plastic and the like. In some embodiments, at least two components of the device 100 are attached together via any means, e.g., welding, gluing and the like. For example, the first plate 110 and second plate may be attached via welding, gluing and the like. In some embodiments, the device 100 is formed from a single piece of material. For example, the first plate 110 and second plate 120 may be formed from a single piece of metal, e.g., by bending the single metal piece at an angle to produce a first plate 110 and a second plate 120.

In some embodiments, the second plate 120 is dimensioned to be placed over the top portion 214 of the support member 210, wherein the second plate 120 can also be bolted to the top portion 214 of the support member 210 via an existing hole 212 on the supporting member. In some embodiments, the first plate 110 attaches to the second plate 120 and drapes downwardly therefrom to shield the PRV 220 from debris coming from the direction of the tire 230 towards the PRV 220.

The present invention also features a system comprising:

a) a pressure relief valve 220 located on a side exterior of a vehicle 200 and is held in a stationary position through a support member 210 that extends outwardly from the vehicle 200;

b) a tire 230 rotatably mounted on the vehicle 200, wherein the tire 230 is positioned towards the front end of the vehicle relative to the pressure relief valve 220, further the tire is capable of projecting debris towards the direction of the pressure relief valve when the tire rotates; and

c) a device for shielding a pressure relief valve 220 from debris projected directly or indirectly by the tire 230, the device comprises a first plate 110 and a second plate 120, the first plate 110 attaches to and extends outwardly from the second plate 120, the first plate 110 is positioned between the pressure relief valve 220 and a tire 230 of a vehicle 200, the second plate 120 is attached to the support member 210.

In some embodiments, the device in the system of the present invention further comprises a third plate 140 that extends outwardly from the second plate 120, and a door member 150 rotatably mounted to the second plate 120, wherein the first plate 110, second plate 120, third plate 140 and door member 150 form an enclosure around the pressure relief valve.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A device for shielding a pressure relief valve from projecting debris, the device comprises a first plate and a second plate, the pressure relief valve is located on a side exterior of a vehicle and is held in a stationary position through a support member that extends outwardly from the vehicle, the first plate attaches to and extends outwardly from the second plate, the first plate is positioned between the pressure relief valve and a tire of a vehicle, the second plate is attached to the support member.

2. The device of claim 1 further comprising a third plate that extends outwardly from the second plate, and a door member rotatably mounted to the second plate, wherein the first plate, second plate, third plate and door member form an enclosure around the pressure relief valve.

3. A system comprising:
a) a pressure relief valve located on a side exterior of a vehicle and is held in a stationary position through a support member that extends outwardly from the vehicle;
b) a tire rotatably mounted on the vehicle, wherein the tire is positioned towards the front end of the vehicle relative to the pressure relief valve, further the tire is capable of projecting debris towards the direction of the pressure relief valve when the tire rotates;
c) device for shielding a pressure relief valve from debris projected by the tire, the device comprises a first plate and a second plate, the first plate attaches to and extends outwardly from the second plate, the first plate is positioned between the pressure relief valve and a tire of a vehicle, the second plate is attached to the support member.

4. The system of claim 3 wherein the device further comprises a third plate that extends outwardly from the second plate, and a door member rotatably mounted to the second plate, wherein the first plate, second plate, third plate and door member form an enclosure around the pressure relief valve.
